(19) United States
(12) Patent Application Publication
(10) Pub. No.: US 2024/0023548 A1
(43) Pub. Date: Jan. 25, 2024

(54) TAU-FLUVALINATE COMPOSITIONS

(71) Applicant: Adama Makhteshim Ltd., Beer Sheva (IL)

(72) Inventors: Liron Hevroni, Meitar (IL); Oren Meiron, Karkur (IL); Gilad Silbert, Kibbutz Dorot (IL)

(73) Assignee: Adama Makhteshim Ltd., Beer Sheva (IL)

(21) Appl. No.: 18/253,814

(22) PCT Filed: Nov. 22, 2021
(86) PCT No.: PCT/IB2021/060834

§ 371 Date: May 22, 2023

Related U.S. Application Data
(60) Provisional application No. 63/117,424, filed on Nov. 23, 2020.

(51) Int. Cl. A01N 37/34; A01N 25/10; A01N 25/12; A01N 25/04; A01P 7/04

(52) U.S. Cl. CPC A01N 37/34; A01N 25/10; A01N 25/12; A01N 25/04; A01P 7/04

(57) ABSTRACT

The present invention relates to a solid composition comprising (1) a guest/host molecular structure comprising tau-fluvalinate and cyclodextrin, and (2) at least one agriculturally acceptable filler. The present invention also relates to an oil-in-water emulsion comprising (1) a guest/host molecular structure comprising tau-fluvalinate and cyclodextrin, and (2) at least one agricultural dispersing agent. The present invention further relates to method of use and processes of preparation of the solid compositions and oil-in-water emulsions.

### CROSS-REFERENCE TO RELATED APPLICATIONS

This application claims priority of Liron Hevroni et al., U.S. Provisional Application No. 63/117,424, filed Nov. 23, 2020, the contents of which are hereby incorporated by reference

Throughout this application various publications are referenced. The disclosures of these documents in their entireties are hereby incorporated by reference into this application in order to more fully describe the state of the art to which this invention pertains.

### TECHNICAL FIELD

The present invention relates to a solid composition comprising (1) a guest/host molecular structure comprising tau-fluvalinate and cyclodextrin, and (2) at least one agriculturally acceptable filler.

### BACKGROUND

Biological activity of tau-fluvalinate is affected by the ability of the active component to penetrate the target such as insect or plant's cuticle (protective film covering the epidermis of leaves which consists of lipid and hydrocarbon polymers impregnated with wax) and its mobility through the multi-layer barrier of the leaves.

Biological activity of the tau-fluvalinate is influenced by parameters that include its physical properties, dispersion and contact over the leaves or the insect. Physical properties refer to lipophilicity, polarity, molecular weight and size.

Interacting tau-fluvalinate with cyclodextrin increases its biological activity spectrum and intensity.

There is a need to develop a composition comprising a guest/host molecular structure, for example in the form of a physical powder mixture blend, of tau-fluvalinate and cyclodextrin.

### SUMMARY OF THE INVENTION

The present invention provides a package comprising a solid composition comprising a guest/host molecular structure comprising tau-fluvalinate and cyclodextrin.

The present invention provides a package comprising any one of the solid compositions described herein.

The present invention provides a solid composition comprising (1) tau-fluvalinate, (2) cyclodextrin, and (3) at least one agriculturally acceptable filler.

The present invention provides a solid composition comprising (1) a guest/host molecular structure comprising tau-fluvalinate and cyclodextrin, and (2) at least one agriculturally acceptable filler.

The present invention provides an oil-in-water emulsion comprising (1) a guest/host molecular structure comprising tau-fluvalinate and cyclodextrin, and (2) at least one dispersing agent.

The present invention provides an oil-in-water emulsion comprising any one of the solid compositions described herein and water.

The present invention provides a method for controlling plant disease caused by insect, comprising contacting a plant, a locus thereof or propagation material thereof with an effective amount of any one of the oil-in-water emulsions described herein so as to thereby control the plant disease.

The present invention provides a method for controlling plant disease caused by insect, comprising (1) obtaining any one of the oil-in-water emulsions described herein, and (2) contacting a plant, a locus thereof or propagation material thereof with an effective amount of the oil-in-water emulsion so as to thereby control the plant disease.

The present invention provides use of cyclodextrin for (i) solidifying tau-fluvalinate, (ii) preparing a solid composition comprising tau-fluvalinate, or (iii) preparing a guest/host molecular structure comprising tau-fluvalinate.

The present invention provides a process for preparing a solid composition comprising tau-fluvalinate, comprising (1) solidifying an amount of tau-fluvalinate using cyclodextrin, and (2) formulating the solidified tau-fluvalinate into a solid composition.

The present invention provides a process for preparing the solid composition described herein comprising (1) obtaining a guest/host molecular complex comprising tau-fluvalinate and cyclodextrin, and (2) mixing at least one additional agriculturally acceptable filler with the guest/host molecular complex.

The present invention provides a process for preparing the solid composition described herein comprising (1) obtaining a guest/host molecular complex comprising tau-fluvalinate and cyclodextrin, and (2) wet-granulation of the guest/host molecular complex with at least one water immiscible liquid and water.

The present invention provides a process for preparing the solid composition described herein comprising (1) obtaining a guest/host molecular structure comprising tau-fluvalinate and cyclodextrin, (2) mixing the guest/host molecular structure with at least one agriculturally acceptable filler, (3) wetting the mixture of step (2) in a mixer using a wetting liquid to obtain a non-compacted powder, (4) drying the non-compacted powder so-obtained. The present invention provides a solid composition prepared using any one of the processes described herein.

The present invention provides a process for preparing the oil-in-water emulsion described herein comprising mixing any one of the solid compositions described herein with water.

The present invention provides a process for preparing the oil-in-water emulsion described herein comprising (1) obtaining a guest/host molecular complex comprising tau-fluvalinate and cyclodextrin, and (2) mixing the guest/host molecular complex with at least one water immiscible liquid and water.

The present invention provides an oil-in-water emulsion prepared using any one of the processes described herein.

### BRIEF DESCRIPTION OF THE DRAWINGS

FIG. 1. Efficacy of the Tau-CD 200EG composition and the Tau-CD 132EW composition towards Spodoptera Littorals 2nd instar larvae.

FIG. 2. Efficacy of the Tau-CD 200EG composition and Mavrik® 240 EW towards Spodoptera Littorals 2nd instar larvae (B, A: 200 ppm; and a: 400 ppm).

FIG. 3. Efficacy of the Tau-CD 200EG composition and Mavrik® 240 EW towards Spodoptera Littorals 2nd instar larvae tested by leaf-dipping in Sunflower leaf discs.

FIG. 4. Representative images of leaves treated with the Tau-CD 200EG composition and Mavrik® 240 EW.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, the term “effective amount” refers to an amount of the tau-fluvalinate, which when ingested, contacted with or sensed, is sufficient to achieve a good level of control.

As used herein, the term “stable” when used in connection with oil-in-water emulsion refers to physical stability of the oil-in-water emulsion. “Physical stability” of the oil-in-water emulsion refers to a state when there is no substantial precipitation of tau-fluvalinate in the emulsion and/or a substantial proportion of tau-fluvalinate in the emulsion is dispersed homogeneously in the emulsion. As used herein, “emulsifiable granules” refers to granules that form oil-in-water emulsion in the presence of water. As used herein “emulsifiable powder” refers to powder that forms oil-in-water emulsion in the presence of water.

As used herein, “concentrated aqueous emulsion composition” (EW), refers to an aqueous emulsion concentrate composition before dilution in water which comprises an organic phase and aqueous phase.

As used herein, an “agriculturally acceptable filler” is a compound that is known and accepted in the art for use in the formation of compositions for agricultural or horticultural use.

As used herein, the term “adjuvant” is defined as any substance that is not an active ingredient but which enhances or is intended to enhance the effectiveness of the active ingredient, for example pesticide, with which it is used. Adjuvants may include, but are not be limited to, spreading agents, penetrants, compatibility agents, and drift retardants.

As used herein, the term “additive” is defined as any substance that is not a pesticide but is added to a pesticidal composition. Examples of additives include, but are not limited to, sticking agents, surfactants, synergists, buffers, acidifiers, defoaming agents and thickeners.

As used herein, the term “tank sprayer” means that the composition is added to water before use, at the time of spray application.

As used herein, the term “plant” includes reference to the whole plant, plant organ (e.g., leaves, stems, twigs, roots, trunks, limbs, shoots, fruits etc.), or plant cells.

As used herein, the term “plant” includes reference to agricultural crops including field crops (soybean, maize, wheat, rice, etc.), vegetable crops (potatoes, cabbages, etc.) and fruits (peach, etc.).

As used herein, the term “propagation material” is to be understood to denote all the generative parts of the plant such as seeds and spores, vegetative structures such as bulbs, corms, tubers, rhizomes, roots stems, basal shoots, stolons and buds.

As used herein, the term “cyclodextrin” refers to a family of polysaccharide compounds made up of sugar molecules bound together in a ring which may also be called cyclic oligosaccharides.

As used herein, a “guest/host molecular structure” refers to the complex of a guest agrochemical molecule with the host cyclodextrin molecule and/or encapsulation of the guest agrochemical molecule within the host cyclodextrin molecular matrix.

Complex may refer to inclusion complex. The complex may be solid. The solid complex may be in the form of a physical powder mixture blend.

Processes of preparing guest/host molecular structure comprising tau-fluvalinate and cyclodextrin are described in WO 2019/215645.

As used herein, the terms “interact chemically” or “interacted chemically” refer to a guest/host molecular structure wherein the guest molecules are complexed with and/or encapsulated within the host molecular matrix. For example, the guest agrochemical molecules are complexed with and/or encapsulated within the cyclodextrin host molecular matrix. “Interact chemically” or “interacted chemically” includes interaction through intermolecular force(s).

As used herein, the term “intermolecular force(s)” may include, but is not limited to, non-covalent interactions such ionic interactions, hydrogen bonds, dipole-dipole interactions, van der Waals interactions and hydrophobic interactions.

As used herein, the term “locus” includes not only areas where insect may already exist, but also areas where insect has yet to emerge, and also to areas under cultivation.

As used herein the term “knockdown treatment” or “knockdown activity” means an application of one or more insecticide for controlling insect infestation of the plant or locus before and/or after an infestation or before and/or after insect damage are shown and/or when the pest pressure is low/high. Insect pressure may be assessed based on the conditions associated with insect development such as population density and certain environmental conditions.

As used herein the term “persistence treatment” or “persistence activity” is used in connection with an insecticide, the term means an application of one or more insecticide for controlling insect infestation of the plant or locus over an extended period of time, before and/or after an infestation or before and/or after insect damage are shown and/or when the insect pressure is low/high. Insect pressure may be assessed based on the conditions associated with insect development such as population density and certain environmental conditions.

As used herein, the term “ha” refers to hectare.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of.”

The term “about” as used herein specifically includes ±10% from the indicated values in the range. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention. For example, “10-50%” includes 10%, 10.1%, 10.2%, etc. up to 50%.

### Solid Compositions

Tau-fluvalinate is liquid at room temperature. It was found that tau-fluvalinate may be efficiently solidified at room temperature by chemically interacting it with cyclodextrin to form a guest/host molecular structure. Processes of preparing a guest/host molecular structure comprising tau-fluvalinate and cyclodextrin are described in WO 2019/215645. The guest/host molecular structure may also be used as a delivery system of tau-fluvalinate for controlling a broad spectrum of insect with enhanced efficacy.

It was found that the solid composition of the present invention comprising solidified tau-fluvalinate and cyclodextrin provides increased biological efficacy compared to non-solid compositions and/or compositions comprising a non-solidified tau-fluvalinate. The commercially available tau-fluvalinate formulation which does not contain cyclodextrin, i.e. Mavrik®, has nearly no efficacy against chewing pests. The compositions as disclosed in this application is effective against chewing pest and controls a broader spectrum of pests. In addition, solid compositions are also easier and less costly to ship and store compared to liquid compositions.

Solid compositions of the present invention are mixed with water prior to application. Tau-fluvalinate is soluble in organic solvents and has low solubility in water. Cyclodextrin is soluble in water. Formulating tau-fluvalinate with cyclodextrin is challenging due to the high rate of dissociation of tau-fluvalinate from the cyclodextrin in the presence of water which leads to sedimentation of tau-fluvalinate.

The solid compositions of the present invention undergo spontaneous emulsification when mixed with water in the tank sprayer before application to the plant. Oil-in-water emulsions prepared using the solid compositions of the present invention have improved physical stability, including improved dispersion of the tau-fluvalinate/cyclodextrin molecular structure and decreased sedimentation of the tau-fluvalinate.

The present invention provides a solid composition comprising (1) tau-fluvalinate, (2) cyclodextrin, and (3) at least one agriculturally acceptable filler.

The present invention provides a solid composition comprising (1) a guest/host molecular structure comprising tau-fluvalinate and cyclodextrin, and (2) at least one agriculturally acceptable filler.

The present invention provides a solid composition comprising (1) a guest/host molecular structure comprising tau-fluvalinate and cyclodextrin and (2) at least one water immiscible liquid.

The present invention provides a solid composition comprising (1) a guest/host molecular structure comprising tau-fluvalinate and cyclodextrin, (2) at least one agriculturally acceptable filler and (3) at least one water immiscible liquid.

In some embodiments, the water immiscible liquid is an oil.

In some embodiment, the water immiscible liquid is a water immiscible organic solvent.

In some embodiments, the solid composition is in the form of powder. In some embodiments, the solid composition is in the form of granules.

In some embodiments, the solid composition is an emulsifiable powder. In some embodiments, the solid composition is an emulsifiable granule.

In some embodiments, the tau-fluvalinate molecules interact chemically with the cyclodextrin molecular matrix through intermolecular force(s).

In some embodiments, the tau-fluvalinate molecules are encapsulated within the cyclodextrin molecular matrix.

In some embodiments, the tau-fluvalinate molecules are complexed with the cyclodextrin molecular matrix.

In some embodiments, the tau-fluvalinate and the cyclodextrin form a guest/host molecular structure.

In some embodiments, the guest/host molecular structure is a complex of tau-fluvalinate and cyclodextrin. In some embodiments, the complex of tau-fluvalinate and cyclodextrin is in the form of a physical powder mixture blend.

In some embodiments, the guest/host molecular structure comprising tau-fluvalinate and cyclodextrin is obtained using any procedure described in WO 2019/215645.

In some embodiments, the guest/host molecular structure comprising tau-fluvalinate and cyclodextrin is prepared using the melting-in process. In some embodiments, the guest/host molecular structure comprising tau-fluvalinate and cyclodextrin is prepared using a co-precipitation process. In some embodiments, the guest/host molecular structure comprising tau-fluvalinate and cyclodextrin is prepared using the kneading process.

In some embodiments, the cyclodextrin is α (alpha)-cyclodextrin: 6-membered sugar ring molecule. In some embodiments, the cyclodextrin is β (beta)-cyclodextrin: 7-membered sugar ring molecule. In some embodiments, the cyclodextrin is γ (gamma)-cyclodextrin: 8-membered sugar ring molecule.

In some embodiments, the cyclodextrin is alkylated. In some embodiments, the cyclodextrin is alkylated with C1-C5 alkyl group. In some embodiments, the cyclodextrin is methylated. In some embodiments, the alkyl group is substituted with hydroxyl group.

Cyclodextrin includes methyl derivatives of cyclodextrin and hydroxypropyl derivatives of cyclodextrin.

In some embodiments, the cyclodextrin is a methyl-beta-cyclodextrin. In some embodiments, the cyclodextrin is a hydroxypropyl-beta-cyclodextrin. In some embodiments, the cyclodextrin is a hydroxypropyl-gamma-cyclodextrin.

Suitable cyclodextrins that may be used in connection with the subject invention include but are not limited to Cavamax™ W7 (beta-cyclodextrin), Cavamax™ W8 (gamma-cyclodextrin), Cavasol™ W7M (methyl-beta-cyclodextrin), Cavasol™ W7HP (hydroxypropyl-beta-cyclodextrin), and Cavasol™ W8HP (hydroxypropyl-gamma-cyclodextrin) manufactured by Wacker Chemie AG.

The size of the cyclodextrin which is used in the present invention correlates with the size and structure of the agrochemical, for example, the pesticide.

In some embodiments, the cyclodextrin has the following structure:

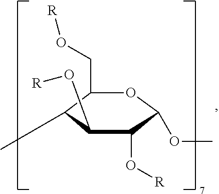

wherein R is H or methyl.

In some embodiments, the cyclodextrin has the following structure:

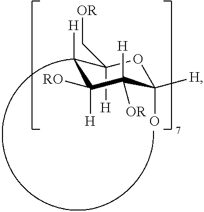

wherein R is

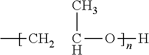

and n is an integer equal to or greater than 0.

In some embodiments, the guest/host molecular structure comprises at least one type of cyclodextrin. In some embodiments, the guest/host molecular structure comprises at least two types of cyclodextrins.

In some embodiments, the agriculturally acceptable filler is water dispersible and/or water soluble. In some embodiments, the agriculturally acceptable filler is a solid filler.

In some embodiments, solid filler may include, but is not limited to, lactose monohydrate, ammonium sulfate, sucrose, magnesium stearate, glucose, cellulose, calcium carbonate and any combination thereof. In some embodiments, the solid filler is ammonium sulfate. In some embodiments, the solid filler is lactose monohydrate.

In some embodiments, the concentration of ammonium sulfate is between about 1% to about 15% by weight based on the total weight of the composition. In some embodiments, the concentration of ammonium sulfate is between about 1% to about 10% by weight based on the total weight of the composition. In some embodiments, the concentration of ammonium sulfate is between about 4% to about 7% by weight based on the total weight of the composition. In some embodiments, the concentration of ammonium sulfate is between about 5% to about 6% by weight based on the total weight of the composition. In some embodiments, the concentration of ammonium sulfate is 5.66% by weight based on the total weight of the composition.

In some embodiments, the concentration of lactose monohydrate is between about 1% to about 15% by weight based on the total weight of the composition. In some embodiments, the concentration of lactose monohydrate is between about 1% to about 10% by weight based on the total weight of the composition. In some embodiments, the concentration of lactose monohydrate is between about 4% to about 7% by weight based on the total weight of the composition. In some embodiments, the concentration of lactose monohydrate is between about 5% to about 6% by weight based on the total weight of the composition. In some embodiments, the concentration of lactose monohydrate is 5.66% by weight based on the total weight of the composition.

In some embodiments, the composition comprises two solid fillers. In some embodiments, the solid fillers are lactose monohydrate and ammonium sulfate.

In some embodiments, the concentration of the agriculturally acceptable filler(s) is between about 1% to about 30% by weight based on the total weight of the composition. In some embodiments, the concentration of the agriculturally acceptable filler(s) is between about 5% to about 15% by weight based on the total weight of the composition. In some embodiments, the concentration of the agriculturally acceptable filler(s) is about 11.32% by weight based on the total weight of the composition.

In some embodiments, the amount of tau-fluvalinate in the solid composition is between about 1% to about 45% by weight based on the total weight of the composition. In some embodiments, the amount of tau-fluvalinate in the solid composition is between about 10% to about 30% by weight based on the total weight of the composition. In some embodiments, the amount of tau-fluvalinate in the solid composition is between about 15% to about 25% by weight based on the total weight of the composition. In some embodiments, the amount of tau-fluvalinate in the solid composition is about 20% by weight based on the total weight of the composition.

In some embodiments, the amount of cyclodextrin in the solid composition is between about 1% to about 90% by weight based on the total weight of the composition. In some embodiments, the amount of cyclodextrin in the solid composition is between about 30% to about 60% by weight based on the total weight of the composition. In some embodiments, the amount of cyclodextrin in the solid composition is between about 40% to about 50% by weight based on the total weight of the composition. In some embodiments, the amount of cyclodextrin in the solid composition is about 46% by weight based on the total weight of the composition.

In some embodiments, the weight ratio of the tau-fluvalinate to the cyclodextrin in the solid composition is between 2:1 to 1:10. In some embodiments, the weight ratio of the tau-fluvalinate to the cyclodextrin in the solid composition is between 1:1 to 1:8. In some embodiments, the weight ratio of the tau-fluvalinate to the cyclodextrin in the solid composition is between 1:1 to 1:6. In some embodiments, the weight ratio of the tau-fluvalinate to the cyclodextrin in the solid composition is between 1:1 to 1:5. In some embodiments, the weight ratio of the tau-fluvalinate to the cyclodextrin in the solid composition is between 1:1 to 1:4. In some embodiments, the weight ratio of the tau-fluvalinate to the cyclodextrin in the solid composition is 1:1. In some embodiments, the weight ratio of the tau-fluvalinate to the cyclodextrin in the solid composition is 1:2. In some embodiments, the weight ratio of the tau-fluvalinate to the cyclodextrin in the solid composition is 1:3. In some embodiments, the weight ratio of the tau-fluvalinate to the cyclodextrin in the solid composition is 1:4.

In some embodiments, the amount of the guest/host molecular structure comprising tau-fluvalinate and cyclodextrin in the solid composition is between about 20% to about 95% by weight based on the total weight of the composition. In some embodiments, the amount of the guest/host molecular structure comprising tau-fluvalinate and cyclodextrin in the solid composition is between about 50% to about 80% by weight based on the total weight of the composition. In some embodiments, the amount of the guest/host molecular structure comprising tau-fluvalinate and cyclodextrin in the solid composition is between about 60% to about 70% by weight based on the total weight of the composition. In some embodiments, the amount of the guest/host molecular structure comprising tau-fluvalinate and cyclodextrin in the solid composition is about 68% by weight based on the total weight of the composition.

In some embodiments, the solid composition comprises a water immiscible liquid. In some embodiments, the water immiscible liquid is an oil. In some embodiment, the water immiscible liquid is a water immiscible organic solvent.

In some embodiments, the oil is selected from the group consisting of vegetable or plant oils and esters thereof, mineral oils, paraffinic oils and any combination thereof.

In some embodiments, the vegetable or plant oil is selected from the group consisting of safflower oil, sunflower oil, pine oil, linseed oil, castor oil, rapeseed oil, soybean oil, and esters thereof. In some embodiments, the ester is a methyl ester.

In some embodiments, the vegetable or plant oil is a methylated seed oil. In some embodiments, the vegetable or plant oil is an unmethylated seed oil.

In some embodiments, the vegetable oil is methylated soybean oil.

In some embodiments, the water immiscible organic solvent is selected from the group consisting of aromatic hydrocarbons, ketones, amides, pyrrolidones and any combination thereof.

In some embodiments, the aromatic hydrocarbon is Solvesso™. In some embodiments, the ketone is cyclohexanone, 2-heptanone or a combination thereof. In some embodiments, the amide is N,N dimethyl decanamide. In some embodiments, the pyrrolidone is N-octyl pyrrolidone (NOP).

In some embodiments, the concentration of the water immiscible liquid is from about 0.10% to about 10% by weight based on the total weight of the composition. In some embodiments, the concentration of the water immiscible liquid is from about 1% to about 5% by weight based on the total weight of the composition. In some embodiments, the concentration of the water immiscible liquid is about 3% by weight based on the total weight of the composition. In some embodiments, the concentration of the water immiscible liquid is 3.4% by weight based on the total weight of the composition.

In some embodiments, the concentration of the oil is from about 0.1% to about 10% by weight based on the total weight of the composition. In some embodiments, the concentration of the oil is from about 1% to about 5% by weight based on the total weight of the composition. In some embodiments, the concentration of the oil is about 3% by weight based on the total weight of the composition. In some embodiments, the concentration of the oil is 3.4% by weight based on the total weight of the composition.

In some embodiments, the solid composition comprises at least one disintegration agent. In some embodiments, agriculturally acceptable filler may include but is not limited to solid fillers.

In some embodiments, the disintegration agent is a blooming agent, an effervescence system or a combination thereof.

In some embodiments, the effervescent system comprises a mixture of an acid and a base, preferably a weak acid and a weak base. However, the effervescent system that may be used with the formulations described herein is not limited to the combination of an acid and a base.

Chemical reaction between an acid and a base can result in a rapid spontaneous evolution of CO2 gas when the effervescent system is combined with and wetted by water. In-situ formation of gas enhances solid disintegration and/or particles dispersion.

Acids may include, but are not limited to, organic and inorganic acids. The inorganic acid may be a weak acid. Organic acids may include but are not limited to carboxylic acids such as citric acid, fumaric acid, phthalic acid, maleic acid, malic acid, oxalic acid, adipic acid, glutaric acid, 2-methyl glutaric acid, succinic acid and tartaric acid or any combination thereof.

Bases may include, but are not limited to, organic and inorganic bases. The inorganic base may be a weak base. Inorganic base may include but are not limited to an alkali metal carbonate or bicarbonate such as lithium carbonate, sodium carbonate, sodium bicarbonate, potassium carbonate, potassium bicarbonate or any combination thereof.

In some embodiments, the concentration of sodium bicarbonate is between about 1% to about 15% by weight based on the total weight of the composition. In some embodiments, the concentration of sodium bicarbonate is between about 1% to about 10% by weight based on the total weight of the composition. In some embodiments, the concentration of sodium bicarbonate is between about 4% to about 7% by weight based on the total weight of the composition. In some embodiments, the concentration of sodium bicarbonate is between about 5% to about 6% by weight based on the total weight of the composition. In some embodiments, the concentration of sodium bicarbonate is 5.66% by weight based on the total weight of the composition.

In some embodiments, the concentration of citric acid is between about 1% to about 15% by weight based on the total weight of the composition. In some embodiments, the concentration of citric acid is between about 1% to about 10% by weight based on the total weight of the composition. In some embodiments, the concentration of citric acid is between about 4% to about 7% by weight based on the total weight of the composition. In some embodiments, the concentration of citric acid is between about 5% to about 6% by weight based on the total weight of the composition. In some embodiments, the concentration of citric acid is 5.66% by weight based on the total weight of the composition.

In some embodiments, the effervescent system comprises a mixture of sodium bicarbonate and citric acid.

In some embodiments, the concentration of the disintegration agent is about 0.1% to about 30% by weight based on the total weight of the composition. In some embodiments, the concentration of the disintegration agent is up to about 15% by weight based on the total weight of the composition. In some embodiments, the concentration of the disintegration agent is about 5% to about 15% by weight based on the total weight of the composition. In some embodiments, the concentration of the disintegration agent is about 11.32% by weight based on the total weight of the composition.

In some embodiments, the concentration of the effervescent system is about 0.1% to about 30% by weight based on the total weight of the composition. In some embodiments, the concentration of the effervescent system is up to about 15% by weight based on the total weight of the composition. In some embodiments, the concentration of the effervescent system is about 5% to about 15% by weight based on the total weight of the composition. In some embodiments, the concentration of the effervescent system is 11.32% by weight based on the total weight of the composition.

In some embodiments, the solid composition comprises at least one additive.

In some embodiments, the additive is solid. In some embodiments, the additive is liquid.

In some embodiments, the additive is selected from the group consisting of dispersing agents, wetting agents, emulsifying agents, anti-foaming agent, biocides, water absorbents, water scavengers, adjuvants and any combination thereof.

In some embodiments, the additive is selected from the group consisting of dispersing agents, wetting agents, emulsifying agents and any combination thereof.

In some embodiments, the composition comprises at least one wetting agent.

In some embodiments, the wetting agent is selected from the group consisting of sodium alkylnaphthalenesulfonate, sodium phenolsulfonic acid, polycondensed formaldehyde, alcohol ethoxylate, sodium lauryl sulfate, polyalkoxylated butyl ether, polyarylphenyl phosphate ether, sodium ducosate, and any combination thereof.

In some embodiments, the wetting agent is a secondary alcohol ethoxylate. In some embodiments, the secondary alcohol ethoxylate is TRITON™ HW-1000.

In some embodiments, the concentration of wetting agent is between about 0.01% to about 10% by weight based on the total weight of the composition. In some embodiments, the concentration of wetting agent is between about 0.1% to about 10% by weight based on the total weight of the composition. In some embodiments, the concentration of wetting agent is between about 0.01% to about 5% by weight based on the total weight of the composition. In some embodiments, the concentration of wetting agent is between about 0.01% to about 2.5% by weight based on the total weight of the composition. In some embodiments, the concentration of wetting agent is between about 0.01% to about 0.5% by weight based on the total weight of the composition. In some embodiments, the concentration of wetting agent is about 0.28% by weight based on the total weight of the composition.

In some embodiments, the composition comprises at least one emulsifying agent.

In some embodiments, the emulsifying agent is selected from the group consisting of alkyl sulfonates, alkyl benzene sulfonates, alkylaryl sulfonates, alkyl phenol alkoxylates, tristyryl phenol ethoxylates, synthetic or natural fatty ethoxylates alcohols synthetic or natural fatty, block copolymers (such as ethylene oxide-propylene oxide block copolymers and ethylene oxide-butylene oxide block copolymers), synthetic or natural fatty alcohol alkoxylates, alkoxylated alcohols (such as poly glycol ether of n-butyl alcohol), polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or poly-oxyalkylene, quaternary ammonium compounds and fatty amine salts, salts of alkylaryl sulfonic acids, salts or sulfated polyglycol ethers, salts of phosphated polyglycol ether and any combination thereof.

In some embodiments, the emulsifier is linear dodecyl benzene sulfonate in 2-ethylhexanol. In some embodiments, the emulsifying agent is Nansa® EVM 70/2E (57% linear dodecyl benzene sulfonate in 2-ethylhexanol).

In some embodiments, the concentration of emulsifying agent is between about 0.010% to about 10% by weight based on the total weight of the composition. In some embodiments, the concentration of emulsifying agent is between about 0.01% to about 5% by weight based on the total weight of the composition. In some embodiments, the concentration of emulsifying agent is between about 0.01% to about 2.5% by weight based on the total weight of the composition. In some embodiments, the concentration of emulsifying agent is between about 0.1% to about 1% by weight based on the total weight of the composition. In some embodiments, the concentration of emulsifying agent is 0.57% by weight based on the total weight of the composition.

In some embodiments, the solid composition comprises at least one dispersing agent.

In some embodiments, the dispersing agent is selected from the group consisting of condensate of alkyl naphthalene sulfonate formaldehyde, alkoxylated alcohol, silicone surfactant, methyl naphthalene sulfonate condensate, sodium salt, ethoxylated fatty alcohol, hydrophobically modified polyacrylate, lignosulfonates, polyelectrolyte block copolymer (as described in WO2017/098325) and any combination thereof.

In some embodiments, the dispersing agent is a block polymer comprises 77% of sodium 2-acryloylamino-2-methylpropane-1-sulfonate (AMPS) monomers and 23% of the ethyl acrylate (EA) monomers.

In some embodiments, the dispersing agent is a water solution of 30% by weight solution of a block polymer comprising 77% of sodium 2-acryloylamino-2-methylpropane-1-sulfonate (AMPS) monomers and 23% of ethyl acrylate (EA) monomers, which may be prepared as described in Example 1 of WO2017/098325. The water content of the solution is dried out of the solid composition as described herein below.

In some embodiments, the concentration of the block polymer is between about 0.1% to about 5% by weight based on the total weight of the composition. In some embodiments, the concentration of the block polymer is between about 0.1% to about 2% by weight based on the total weight of the composition. In some embodiments, the concentration of the block polymer is 0.51% by weight based on the total weight of the composition.

In some embodiments, the dispersing agent is a vinyl pyrrolidone/vinyl acetate copolymer. In some embodiments, the vinyl pyrrolidone/vinyl acetate copolymer is Agrimer VA-6.

In some embodiments, the concentration of the vinyl pyrrolidone/vinyl acetate copolymer is between about 1% to about 10% by weight based on the total weight of the composition. In some embodiments, the concentration of the vinyl pyrrolidone/vinyl acetate copolymer is between about 2% to about 7% by weight based on the total weight of the composition. In some embodiments, the concentration of the vinyl pyrrolidone/vinyl acetate copolymer is between about 4% to about 5% by weight based on the total weight of the composition. In some embodiments, the concentration of the vinyl pyrrolidone/vinyl acetate copolymer is 4.53% by weight based on the total weight of the composition.

In some embodiments, the solid composition comprises at least two dispersing agents.

In some embodiments, the dispersing agents are vinyl pyrrolidone/vinyl acetate copolymer and PVP-vinyl acetate copolymer. In some embodiments, the dispersing agents are Agrimer VA-6 and PVP-vinyl acetate copolymer.

In some embodiments, the dispersing agent is used also as emulsifier agent.

In some embodiments, the concentration of dispersing agent(s) is between about 1% to about 10% by weight based on the total weight of the composition. In some embodiments, the concentration of dispersing agent(s) is between about 2% to about 8% by weight based on the total weight of the composition. In some embodiments, the concentration of dispersing agent(s) is about 3% to about 7% by weight based on the total weight of the composition. In some embodiments, the concentration of dispersing agent(s) is 5.04% by weight based on the total weight of the composition.

In some embodiments, the composition comprises at least one additional active ingredient.

In some embodiments, the solid composition comprises TRITON™ HW-1000 (secondary alcohol ethoxylate, non-ionic hydrocarbon surfactant biodegradable as well as free of alkylphenol ethoxylates (APE)).

In some embodiments, the solid composition comprises Nansa EVM70/2E (57% linear dodecyl benzene sulfonate in 2-ethylhexanol).

In some embodiments, the solid composition comprises a secondary alcohol ethoxylate.

In some embodiments, the solid composition comprises linear dodecyl benzene sulfonate in 2-ethylhexanol.

In some embodiments, the solid composition comprises (a) a guest/host molecular structure comprising tau-fluvalinate and cyclodextrin, (b) methyl soyate, (c) TRITON™ HW-1000 (secondary alcohol ethoxylate, non-ionic hydrocarbon surfactant biodegradable as well as free of alkylphenol ethoxylates (APE)), and (d) Nansa EVM70/2E (57% linear dodecyl benzene sulfonate in 2-ethylhexanol).

In some embodiments, the solid composition is stored for a period between 2 weeks and 6 months prior to application. In some embodiments, the solid composition is stored for 2 weeks prior to application. In some embodiments, the solid composition is stored for 1 month prior to application. In some embodiments, the solid composition is stored for 2 months prior to application. In some embodiments, the solid composition is stored for 3 months prior to application. In some embodiments, the solid composition is stored for 6 months prior to application.

In some embodiments, the solid composition is stored at a temperature between −15° C. to 50° C. In some embodiments, the solid composition is stored at a temperature between −15° C. to 0° C. In some embodiments, the solid composition is stored at a temperature between 0° C. to 10° C. In some embodiments, the solid composition is stored at a temperature between 10° C. to 20° C. In some embodiments, the solid composition is stored at a temperature between 20° C. to 25° C. In some embodiments, the solid composition is stored at a temperature between 25° C. to 50° C.

In some embodiments, the solid composition is stable. In some embodiments, the solid composition is chemically stable. In some embodiments, the solid composition is physically stable. In some embodiments, the solid composition is stable after storage, including storage for the durations described above at temperatures described above.

The present invention provides a solid composition comprising (1) tau-fluvalinate in amount of about 20% by weight based on the total weight of the composition (2) methyl-beta-cyclodextrin in amount of about 46% by weight based on the total weight of the composition, (3) an oil in amount of about 3% by weight based on the total weight of the composition (4) disintegration agent in amount of about 11% by weight based on the total weight of the composition (5) filler in amount of about 11% by weight based on the total weight of the composition and (6) additional additive.

The present invention provides a solid composition comprising:
(1) about 60% to about 70% by weight of the guest/host molecular structure comprising tau-fluvalinate and cyclodextrin based on the total weight of the composition,
(2) about 0.1% to about 2% by weight of a block polymer comprising 77% of sodium 2-acryloylamino-2-methylpropane-1-sulfonate (AMPS) monomers and 23% of ethyl acrylate (EA) monomers based on the total weight of the composition,
(3) about 0.01% to about 0.5% by weight of a secondary alcohol ethoxylate based on the total weight of the composition,
(4) about 1% to about 5% by weight of methylated soybean oil based on the total weight of the composition,
(5) about 0.1% to about 1% by weight of 57% linear dodecyl benzene sulfonate in 2-ethylhexanol based on the total weight of the composition,
(6) about 5% to about 6% by weight of sodium bicarbonate based on the total weight of the composition,
(7) about 5% to about 6% by weight of citric acid based on the total weight of the composition,
(8) about 5% to about 6% by weight of ammonium sulfate based on the total weight of the composition,
(9) about 5% to about 6% by weight of lactose monohydrate based on the total weight of the composition, and
(10) about 4% to about 5% by weight of the composition of vinyl pyrrolidone/vinyl acetate copolymer based on the total weight of the composition.

The present invention provides a solid composition comprising:
(1) 67.23% by weight of the guest/host molecular structure comprising tau-fluvalinate and cyclodextrin based on the total weight of the composition,
(2) 0.51% by weight of a block polymer comprising 77% of sodium 2-acryloylamino-2-methylpropane-1-sulfonate (AMPS) monomers and 23% of ethyl acrylate (EA) monomers based on the total weight of the composition,
(3) 0.28% by weight of a secondary alcohol ethoxylate based on the total weight of the composition,
(4) 3.4% by weight of methylated soybean oil based on the total weight of the composition,
(5) 0.57% by weight of 57% linear dodecyl benzene sulfonate in 2-ethylhexanol based on the total weight of the composition,
(6) 5.66% by weight of sodium bicarbonate based on the total weight of the composition,
(7) 5.66% by weight of citric acid based on the total weight of the composition,
(8) 5.66% by weight of ammonium sulfate based on the total weight of the composition,
(9) 5.66% by weight of lactose monohydrate based on the total weight of the composition, and
(10) 4.53% by weight of the composition of vinyl pyrrolidone/vinyl acetate copolymer based on the total weight of the composition.

The present invention provides a package comprising any one of the solid compositions described herein. The present invention provides a package comprising (1) a guest/host molecular structure comprising tau-fluvalinate and cyclodextrin, and (2) at least one agriculturally acceptable filler. The present invention provides a package comprising a solid composition comprising a guest/host molecular structure comprising tau-fluvalinate and cyclodextrin.

### Oil-In-Water Emulsions

When the solid composition of the present invention is mixed with water, the solid composition undergoes spontaneous emulsification.

The present invention provides an oil-in-water emulsion comprising any one of the solid compositions described herein and water. The oil-in-water emulsion prepared from the solid compositions described herein may comprise the components of the solid compositions described herein.

The present invention provides an oil-in-water emulsion comprising (1) a guest/host molecular structure comprising tau-fluvalinate and cyclodextrin, and (2) at least one dispersing agent.

The oil-in-water emulsion may comprise any one or any combination of the components of the solid composition described herein. The oil-in-water emulsion may also comprise additional components.

In some embodiments, the oil-in-water emulsion is physically stable.

In some embodiments, physical stability of the oil-in-water emulsion refers to a state when there is no substantial precipitation of tau-fluvalinate in the emulsion and/or a substantial proportion of tau-fluvalinate in the emulsion is dispersed homogeneously in the emulsion.

In some embodiments, the dispersing agent is selected from the group consisting of condensate of alkyl naphthalene sulfonate formaldehyde, alkoxylated alcohol, silicone surfactant, methyl naphthalene sulfonate condensate, sodium salt, ethoxylated fatty alcohol, hydrophobically modified polyacrylate, lignosulfonates, polyelectrolyte block copolymer and any combination thereof.

In some embodiments, the dispersing agent is a 30% by weight aqueous solution of a block polymer comprising 77% of sodium 2-acryloylamino-2-methylpropane-1-sulfonate (AMPS) monomers and 23% of the ethyl acrylate (EA) monomers.

In some embodiments, the dispersing agent is a vinyl pyrrolidone/vinyl acetate copolymer.

In some embodiments, the composition comprises two dispersing agents.

In some embodiments, the two dispersing agents are vinyl pyrrolidone/vinyl acetate copolymer and PVP-vinyl acetate copolymer.

In some embodiments, the oil-in-water emulsion comprises a water immiscible liquid. In some embodiment, the water immiscible liquid is an oil. In some embodiment, the water immiscible liquid is a water immiscible organic solvent. Presence of a water immiscible liquid enhances the physical stability of the oil-in-water emulsion.

In some embodiments, the oil is selected from the group consisting of vegetable and plant oils and esters thereof, mineral oils, paraffinic oils and any combination thereof.

In some embodiments, the vegetable and plant oil is selected from the group consisting of sunflower oil, pine oil, linseed oil, castor oil, rapeseed oil, soybean oil, and esters thereof.

In some embodiments, the vegetable oil is methylated soybean oil.

In some embodiments, the water immiscible organic solvent is selected from the group consisting of aromatic hydrocarbons, ketones, amides, pyrrolidones and any combination thereof.

In some embodiments, the aromatic hydrocarbon is a naphtha solvent. In some embodiments, the aromatic hydrocarbon is Solvesso™.

In some embodiments, the ketone is cyclohexanone, 2-heptanone or a combination thereof.

In some embodiments, the amide is N,N dimethyl decanamide.

In some embodiments, the pyrrolidone is N-octyl pyrrolidone (NOP).

In some embodiment, the oil-in-water emulsion comprises at least one additive. Presence of additive(s) enhance the physical stability of the oil-in-water emulsion by minimizing the droplet size of the resultant emulsion after mixing the solid composition with water or dispersing the guest/host molecular structure comprising tau-fluvalinate and cyclodextrin in water. In some embodiments, the additive is at least one surfactant.

In some embodiment, the oil-in-water emulsion comprises at least one surfactant. Presence of surfactant(s) enhance the physical stability of the oil-in-water emulsion by minimizing the droplet size of the resultant emulsion after mixing the solid composition with water or dispersing the guest/host molecular structure comprising tau-fluvalinate and cyclodextrin in water.

In some embodiments, the additive is selected from the group consisting of PolyAgro A (as described hereinbelow), Nansa EVM 70/E, Agrimer VA-6 and a combination thereof.

In some embodiments, the surfactant is selected from the group consisting of PolyAgro A (as described hereinbelow), Nansa EVM 70/E, Agrimer VA-6 and a combination thereof.

The disintegration rate of the solid composition in water also affects physical stability of the emulsion.

In some embodiments, the oil-in-water emulsion comprises at least one disintegration agent enhancer. Presence of a disintegration agent enhancer may minimize the time it takes to disperse the solid composition and to increase the emulsion's physical stability.

In some embodiments, the oil-in-water emulsion comprises TRITON™ HW-1000 (secondary alcohol ethoxylate, non-ionic hydrocarbon surfactant biodegradable as well as free of alkylphenol ethoxylates (APE)).

In some embodiments, the oil-in-water emulsion comprises Nansa EVM70/2E (57% linear dodecyl benzene sulfonate in 2-ethylhexanol).

In some embodiments, the oil-in-water emulsion comprises a secondary alcohol ethoxylate.

In some embodiments, the oil-in-water emulsion comprises linear dodecyl benzene sulfonate in 2-ethylhexanol.

In some embodiments, the oil-in-water emulsion is stored for a period between 2 weeks and 6 months prior to application. In some embodiments, the oil-in-water emulsion is stored for 2 weeks prior to application. In some embodiments, the oil-in-water emulsion is stored for 1 month prior to application. In some embodiments, the oil-in-water emulsion is stored for 2 months prior to application. In some embodiments, the oil-in-water emulsion is stored for 3 months prior to application. In some embodiments, the oil-in-water emulsion is stored for 6 months prior to application.

In some embodiments, the oil-in-water emulsion is stored at a temperature between −15° C. to 50° C. In some embodiments, the oil-in-water emulsion is stored at a temperature between −15° C. to 0° C. In some embodiments, the oil-in-water emulsion is stored at a temperature between 0° C. to 10° C. In some embodiments, the oil-in-water emulsion is stored at a temperature between 10° C. to 20° C. In some embodiments, the oil-in-water emulsion is stored at a temperature between 20° C. to 25° C. In some embodiments, the oil-in-water emulsion is stored at a temperature between 25° C. to 50° C.

In some embodiments, the oil-in-water emulsion is stable. In some embodiments, the oil-in-water emulsion is physically stable. In some embodiments, the oil-in-water emulsion is stable after storage, including storage for the durations described above at temperatures described above.

### METHODS OF USE

The present invention provides a method for controlling plant disease caused by insect, comprising contacting a plant, a locus thereof or propagation material thereof with an effective amount of any one of the herein disclosed oil-in-water emulsions so as to thereby control the plant disease.

The present invention also provides a method for controlling unwanted insects comprising applying an effective amount of any one of the herein described oil-in-water emulsions to an area infested with the unwanted insects so as to thereby control the unwanted insects.

The present invention also provides a method for controlling plant disease caused by insect, comprising (1) obtaining an oil-in-water emulsion as described herein, and (2) contacting a plant, a locus thereof or propagation material thereof with an effective amount of the oil-in-water emulsion so as to thereby control the plant disease.

The present invention also provides a method for controlling unwanted insects comprising (1) obtaining an oil-in-water emulsion as described herein, and (2) applying an effective amount of the oil-in-water emulsion to an area infested with the unwanted insects so as to thereby control the unwanted insects.

In some embodiments, the oil-in-water emulsion is obtained using one of the processes of preparation described herein below.

The present invention also provides a method for controlling unwanted insects comprising (1) obtaining a solid composition described herein, (2) mixing the solid composition with water to obtain an oil-in-water emulsion, and (3) applying an effective amount of the oil-in-water emulsion to an area infested with the unwanted insects so as to thereby control the unwanted insects.

The present invention also provides a method for controlling plant disease caused by insect, comprising (1) obtaining a solid composition described herein, (2) mixing the solid composition with water to obtain an oil-in-water emulsion, and (3) contacting a plant, a locus thereof or propagation material thereof with an effective amount of the oil-in-water emulsion so as to thereby control the plant disease.

In some embodiments, the solid composition is obtained using one of the processes of preparation described herein below.

In some embodiments, the area infested with unwanted insects is a plant. In some embodiments, the area infested with unwanted insects is soil.

Controlling unwanted insect infestation in an area includes preventing infestation by unwanted insects and/or reducing the number of unwanted insects in the area.

Controlling plant disease caused by insect includes curing and/or preventing the plant disease.

The oil-in-water emulsion applied for controlling unwanted insect infestation and/or plant disease may be applied as persistence treatment and/or knock down treatment.

In some embodiments, the method is effective for preventing infestation by unwanted insects. In some embodiments, the method is effective for reducing the number of unwanted insects in the area.

In some embodiments, the method is effective for preventing the plant disease caused by insects. In some embodiments, the method is effective for curing the plant disease caused by insects.

In some embodiments, the oil-in-water emulsion is applied as a persistence treatment. In some embodiments, the oil-in-water emulsion is applied as a knockdown treatment.

In some embodiments, the oil-in-water emulsion is applied at a rate from about 100 ppm to about 1000 ppm of tau-fluvalinate. In some embodiments, the oil-in-water emulsion is applied at a rate from about 100 ppm to about 500 ppm of tau-fluvalinate. In some embodiments, the oil-in-water emulsion is applied at a rate from about 200 ppm to about 400 ppm of tau-fluvalinate. In some embodiments, the oil-in-water emulsion is applied at a rate of about 200 ppm of tau-fluvalinate. In some embodiments, the oil-in-water emulsion is applied at a rate of about 400 ppm of tau-fluvalinate.

In some embodiments, the oil-in-water emulsion is applied to soil. In some embodiment, the oil-in-water emulsion is applied to foliage.

In some embodiments, the method comprises mixing the solid composition with water to obtain an oil-in-water emulsion in a water tank prior to application.

### Preparation of the Solid Composition

The present invention provides the use of cyclodextrin for solidifying tau-fluvalinate.

The present invention provides the use of cyclodextrin for preparing a solid composition comprising tau-fluvalinate.

The present invention provides a process for preparing a solid composition comprising tau-fluvalinate, comprising (1) solidifying an amount of tau-fluvalinate using cyclodextrin, and (2) formulating the solidified tau-fluvalinate into a solid composition.

The present invention provides the use of cyclodextrin for preparing a guest/host molecular structure comprising tau-fluvalinate.

The present invention provides a process for preparing the solid composition described herein comprising (1) obtaining a guest/host molecular complex comprising tau-fluvalinate and cyclodextrin, and (2) mixing at least one additional agriculturally acceptable filler with the guest/host molecular complex.

The present invention provides a process for preparing the solid composition described herein comprising (1) obtaining a guest/host molecular complex comprising tau-fluvalinate and cyclodextrin, and (2) wet-granulation of the guest/host molecular complex with at least one water immiscible liquid and water.

The present invention provides a process for preparing the solid composition described herein comprising (1) obtaining a guest/host molecular structure comprising tau-fluvalinate and cyclodextrin, (2) mixing the guest/host molecular structure with at least one agriculturally acceptable filler, (3) wet granulation of the mixture of step (2) using a wetting liquid to obtain granules, and (4) drying the obtained granules.

The present invention provides a process for preparing the solid composition described herein comprising (1) obtaining a guest/host molecular structure comprising tau-fluvalinate and cyclodextrin, (2) mixing the guest/host molecular structure with at least one agriculturally acceptable filler, (3) wetting the mixture of step (2) in a mixer using a wetting liquid to obtain a non-compacted powder, (4) drying the non-compacted powder so-obtained.

In some embodiment, the wetting liquid is sprayed onto the mixture of step (2) to obtain granules.

The guest/host molecular structure comprising tau-fluvalinate and cyclodextrin may be obtained using the process of preparation as described in WO 2019/215645.

In some embodiments, the guest/host molecular structure comprising tau-fluvalinate and cyclodextrin is prepared using the melting-in process. In some embodiments, the guest/host molecular structure comprising tau-fluvalinate and cyclodextrin is prepared using a co-precipitation or kneading process.

Suitable cyclodextrins and agriculturally acceptable fillers that may be used in connection with the subject invention, including in the processes of the subject invention, are described herein above.

In some embodiments, step (2) further comprises mixing the guest/host molecular structure with at least one additive.

Suitable additives that may be used in connection with the subject invention, including in the processes of the subject invention, are described herein above.

In some embodiments, a water immiscible liquid is mixed with the guest/host molecular structure during wetting. In some embodiments, an oil is mixed with the guest/host molecular structure during wetting.

In some embodiments, the wetting liquid used in step (3) is an aqueous liquid. In some embodiments, the wetting liquid used in step (3) is water.

In some embodiments, the wetting liquid used in step (3) is an emulsion of at least one water immiscible liquid in water. In some embodiments, the wetting liquid used in step (3) is an emulsion of an oil-comprising component in water.

In some embodiments, the weight ratio of the wetting liquid to the guest/host molecular structure is from about 1:1 to about 1:10. In some embodiments, the weight ratio of the wetting liquid to the guest/host molecular structure is from about 1:4 to about 1:7. In some embodiments, the weight ratio of the wetting liquid to the guest/host molecular structure is from about 1:5 to about 1:6. In some embodiments, the weight ratio of the wetting liquid to the guest/host molecular structure is 1:5.5.

Suitable water immiscible liquids that may be used in connection with the subject invention, including in the processes of the subject invention, are described herein above.

In some embodiments, a disintegration agent is mixed with the guest/host molecular structure prior to performing the wet granulation of step (3).

Suitable disintegration agents that may be used in connection with the subject invention, including in the processes of the subject invention, are described herein above.

Wet granulation includes but is not limited to pan granulation. In some embodiments, the wet granulation is pan granulation.

Alternatively, one or more of the following methods may be used to prepare the solid compositions described herein: (1) mixing agglomeration, (2) drum granulation and (3) fluid bed granulation.

In some embodiments, the obtained granules are dried using a fluidized bed. In some embodiments, the obtained granules are dried by lyophilization of the remaining solution. In some embodiments, the obtained granules are dried by spray-drying. In some embodiments, the obtained granules are dried freeze-drying. In some embodiments, the obtained granules are dried by diafiltration. In some embodiments, the obtained granules are dried by dialysis. In some embodiments, the obtained granules are dried by vacuum drying. In some embodiments, the obtained granules are dried by heat drying.

In some embodiments, the solid composition is packed in water-soluble packaging.

The present invention also provides a solid composition prepared using any one of the processes described herein.

### Preparation of the Oil-In-Water Emulsion

The present invention also provides a process for preparing the oil-in-water emulsion described herein comprising mixing any one of the solid compositions described herein with water.

The present invention also provides a process for preparing the oil-in-water emulsion described herein comprising (1) obtaining a guest/host molecular complex comprising tau-fluvalinate and cyclodextrin, and (2) mixing the guest/host molecular complex with at least one water immiscible liquid and water.

In some embodiments, step 2 of the process comprises (i) mixing the guest/host molecular complex and at least one emulsifier in a water immiscible liquid to prepare an oil phase, (ii) dissolving at least one wetting agent and/or dispersing agent in water to prepare a water phase, and (iii) mixing the oil phase with the water phase to prepare the oil-in-water emulsion.

The guest/host molecular structure comprising tau-fluvalinate and cyclodextrin may be obtained using the process of preparation as described in WO 2019/215645.

In some embodiments, the guest/host molecular structure comprising tau-fluvalinate and cyclodextrin is prepared using the melting-in process. In some embodiments, the guest/host molecular structure comprising tau-fluvalinate and cyclodextrin is prepared using a co-precipitation process. In some embodiments, the guest/host molecular structure comprising tau-fluvalinate and cyclodextrin is prepared using the kneading process.

In some embodiments, the water immiscible liquid is an oil.

Suitable water immiscible liquids that may be used in connection with the subject invention, including in the processes of the subject invention, are described herein above.

In some embodiments, the process further comprises mixing the guest/host molecular structure with at least one agriculturally acceptable filler, additive, and/or disintegration agent.

Suitable agriculturally acceptable fillers, additives, and disintegration agents that may be used in connection with the subject invention, including in the processes of the subject invention, are described herein above.

The present invention also provides an oil-in-water emulsion prepared using any one of the processes described herein.

Each embodiment disclosed herein is contemplated as being applicable to each of the other disclosed embodiments. Thus, all combinations of the various elements described herein are within the scope of the invention. In addition, the elements recited in composition embodiments can be used in the oil-water-emulsion, method, use, process and package embodiments described herein and vice versa.

In addition, when lists are provided, the list is to be considered as a disclosure of any one member of the list.

This invention will be better understood by reference to the Experimental Details which follow, but those skilled in the art will readily appreciate that the specific experiments detailed are only illustrative of the invention as described more fully in the claims which follow thereafter.

The invention is illustrated by the following examples without limiting it thereby.

### EXPERIMENTAL SECTION

### Example 1—Stable Emulsifiable Granule (EG) Composition with 20% by Weight of Solid Tau-Fluvalinate (Tau-CD 200EG Formulation)

Materials

Tau-Fluvalinate-Cyclodextrin Complex—complexation of tau-fluvalinate with CAVASOL® W7M was performed by the co-precipitation method as disclosed in WO 2019/215645 at pesticide-cyclodextrin weight % of 35% tau-fluvalinate and 65% cyclodextrin. The tau-fluvalinate-cyclodextrin complex was prepared by dissolving both the tau-fluvalinate and the cyclodextrin in acetone, ethanol or methanol. CAVASOL®W7M (250 g) and tau-fluvalinate (135 g) were dissolved in the organic solvent and mixed for several hours at 35° C. to 50° C. After the reactions, the solvent was evaporated until complete dryness, and the dried physical powder mixture blend of tau fluvalinate-cyclodextrin was obtained.

Complexation of tau-fluvalinate with CAVASOL® W7M was also performed by a kneading method at the same pesticide-cyclodextrin weight % of 35% tau-fluvalinate and 65% cyclodextrin. The tau-fluvalinate-cyclodextrin complex was prepared by dissolving CAVASOL®W7M (1850 g) into a solution of 50/50 (weight-%) Ethanol/Water and filling into a baking/kneading machine. Tau-Fluvalinate was then added to that solution and the paste formed kneaded for 6 hours at 35° C. The Ethanol/Water was evaporated at 35° C. In order to completely dry the material, the wet powder was dried in an oven at 40° C. and 1 mbar for 16 hours.

PolyAgro A—PolyAgro A is a di-block copolymer, with a total weight of 17000 g/mol, composed of a hydrophobic block (Anchor block—ANCHOR) and a hydrophilic block (Stabilizing block—STAB). The stabilizing, hydrophilic, block is made of sodium 2-Acryloylamino-2-methylpropane-1-sulfonate (AMPS) monomers, which are 77% of the overall monomers in the polymer. The other 23% of the monomers belongs to the anchor, hydrophobic, block which is made of ethyl acrylate monomers. The total amount of monomers in the polymer (degree of polymerization, DPn) is 85 monomers.

This polymer may be obtained according to the following procedure.

a) Macro CTA

Into a 2 L double jacketed reactor equipped with mechanical agitator and reflux condenser was added 11.26 g of O-ethyl-S-(1-methoxycarbonylethyl)xanthate (CH3CH(CO2CH3))S(C═S)OEt), 264.08 g of Ethanol, and 356.32 g of De-ionized water and 1400 g of AMPS(Na) solution (50% active) and 1.52 g of 4,4′-Azobis(4-cyanopentanoic acid). The reactor contents were heated to 70° C. under agitation and nitrogen. The reaction mixture was aged at 70° C. for a further hour whereupon it was cooled to ambient temperature and discharged. The measured solids content was 37.6% (115° C., 60 mins). GPC Mals: Mn=16300 Mw=2600 IP=1.6.

b) Chain Extension

Into a 5 L double jacketed reactor equipped with mechanical agitator and reflux condenser was added 2127 g of macro CTA solution (see a) and 330 g of de-ionized water. The reactor contents were heated to 70° C. under agitation and a nitrogen stream. Once 70° C. was reached, 106.67 g of ethyl acrylate (EA) was added over 2H00 and a 37.37 g of a solution of 10 wt % of 4,4′-Azobis(4-cyanopentanoic acid) was concomitantly added over 2h30. After the end of the introduction of the initiator solution, the reaction solution was further aged for one hour. Thereafter a shot of 44.85 g of a 10 wt % solution of 4,4′-Azobis(4-cyanopentanoic acid) was added and the mixture aged at 70° C. for a further hour whereupon it was cooled to ambient temperature and discharged. The measured solids content was 40.0% (115° C., 60 mins).

Ethanol was removed from the polymer solution using a rotary evaporator. Water was back added to achieve a polymer solution with a final solids content of 40.4%.

2600 g of polymer solution was placed in a 5 L double jacketed reactor equipped with mechanical agitator and reflux condenser. The pH of the solution was increased to 8.5 using a 50% solution of NaOH. The mixture was heated to 70° C. with stirring whereupon 48.4 of a 30% solution of hydrogen peroxide was added in 1 hour. At the end of the additions, the solution was aged for a further 3h00 whereupon it was cooled and discharged.

The residuals monomers were measure by HPLC and GC (AMPS=22 ppm, EA=2 ppm).

The measured solids content was 37.5%. The polymer is used in the composition of the present invention as a ready aqua polymer solution at concentration of about 30% w/w.

TABLE 1
PolyAgro A

| | | | | Total | STAB | ANCHOR | | |
|---|---|---|---|---|---|---|---|---|
| AMPS | EA | AMPS | EA | Mnth | Mnth | Mnth | Dpn | Dpn |
| (mol %) | (mol %) | (wt %) | (wt %) | (g/mol) | (g/mol) | (g/mol) | STAB | ANCHOR |
| 77 | 23 | 88 | 12 | 17000 | 15000 | 2000 | 65 | 20 |

Procedure

The exact composition and ingredients weight % that were used for preparation is described in Table 2. The composition after drying of the granules is described in Table 3.

All the dry ingredients (tau-fluvalinate-CD, sodium bicarbonate, citric acid, lactose, ammonium sulfate, and Agrimer VA6) were mixed and milled in a tube mill for 1 min.

Premix 1: Triton HW-1000 and PolyAgro A were added to 10.75 gr water and stirred.

Premix 2: In a different vessel, the methyl soyate and Nansa EVM 70/2E were stirred. The methyl soyate premix 2 was added to the water premix 1 and stirred for ˜1 minute until a homogenous emulsion was formed. The dry powder was placed in the pan granulator and spinning at a rate of 350 RPM was started. The wetting liquid was loaded into the spray gun and was sprayed on the powder at a slow but steady rate. After small granules formed, the pan was stopped and the granules were transferred to the fluidized bed, dried. Drying was at very low air rates (10-25) and low temp of ˜45-55° C. Only mild drying was required.

TABLE 2
Preparation of Tau-CD 200EG for granulation

| | | | % | g per |
|---|---|---|---|---|
| Name | function | manufacturer | w/w | 100 g |
| Tau-CD (31%) | | Wacker | 60% | 60 |
| water | | | 10.75% | 10.75 |
| PolyAgro A | Dispersing | | 1.5% | 1.5 |
| (AMPS-block-EA, | agent/ | | | |
| 30% by weight | Emulgator | | | |
| aqueous solution) | | | | |
| TRITON ™ HW- | Wetter | DOW | 0.25% | 0.25 |
| 1000 Surfactant | | | | |
| METHYL SOYATE | solvent | BASF | 3% | 3 |
| Nansa EVM70/2E | Emulgator | INNOSPEC | 0.5% | 0.5 |
| Sodium Bicarbonate | Effervescence | | 5% | 5 |
| | agent | | | |
| Citric Acid | Effervescence | | 5% | 5 |
| | agent | | | |
| Lactose edible grade | Filler | | 5% | 5 |
| Ammonium sulfate | Filler | | 5% | 5 |
| Agrimer VA 6 | Dispersing | Ashland | 4% | 4 |
| | agent | | | |

TABLE 3
Stable Tau-CD 200EG formulation (after drying)

| | | | % | g per |
|---|---|---|---|---|
| Name | function | manufacturer | w/w | 100 g |
| Tau-CD (31%) | | Wacker | 68.07% | 68.07 |
| PolyAgro A | Dispersing | | 0.51% | 0.51 |
| (100% AMPS- | agent/ | | | |
| block-EA) | Emulgator | | | |
| TRITON ™ HW- | Wetter | DOW | 0.28% | 0.28 |
| 1000 Surfactant | | | | |
| METHYL SOYATE | solvent | BASF | 3.4% | 3.4 |
| Nansa EVM70/2E | Emulgator | INNOSPEC | 0.57% | 0.57 |
| Sodium Bicarbonate | Effervescence | | 5.66% | 5.66 |
| | agent | | | |
| Citric Acid | Effervescence | | 5.66% | 5.66 |
| | agent | | | |
| Lactose edible grade | Filler | | 5.66% | 5.66 |
| Ammonium sulfate | Filler | | 5.66% | 5.66 |
| Agrimer VA 6 | Dispersing | Ashland | 4.53% | 4.53 |
| | agent | | | |

The granules dispersed well in water. Sieve test showed only a small amount of insoluble residue. Circulation test through a 150 μm sieve was performed to ensure that the formulation can be sprayed. Circulation test results were excellent. No residue was found on the filter after 2 hours of circulation.

### Example 2—Comparative Composition of Concentrated Aqueous Emulsion (EW) Formulation of Tau-Fluvalinate-Cyclodextrin (CD) Complex

Procedure

The components of the composition may be obtained as described in Example 1 above.

0.5% Lankropol K02, 1.8% PolyAgro A, 1.8% CO-20, 4% Solvesso 100, and 0.04% SAG 1572 were added to 45.22% soft water and mixed until a homogeneous mixture was obtained. 40% Tau-CD were added slowly and the mixture was stirred until it was homogenous. The mixture was then further homogenized using IKA T 25 digital ULTRA-TURRAX® disperser at 15,000 RPM for ca. 4 minutes, until emulsion droplet size, as measured by Malvern Mastersizer 3000, was below 4.5 um. 0.04% SAG 1572, 4% propylene glycol and 2.6% of Xanthan gum pregel (2.7% xanthan gum, 1.35% Proxel GXL in water) were added and stirred until the mixture was homogenous.

The EW formulation is summarized in Table 4.

TABLE 4
Concentrated aqueous emulsion (EW) formulation of tau-
fluvalinate-CD complex (Tau-CD 132EW formulation)

| | | | % | g per |
|---|---|---|---|---|
| Name | function | manufacturer | w/w | 100 g |
| Lankropol KO2 | Wetting agent | Nouryon | 0.5% | 0.5 |
| PolyAgro A | Dispersing | | 1.8% | 1.8 |
| (AMPS-block- | agent/Emulgator | | | |
| EA, 30% by | | | | |
| weight aqueous | | | | |
| solution ) | | | | |
| Agnique CSO- | Emulgator | BASF | 1.8% | 1.8 |
| 20 | | | | |
| Solvesso 100 | Solvent | Exxson Mobil | 4% | 4 |
| SAG 1572 | Anti-foam | Momentive | 0.08% | 0.08 |
| Soft water | | | 45.22% | 45.22 |
| Tau-CD (31%) | | | 40% | 40 |
| Propylene | Antifreeze | | 4% | 4 |
| glycol | | | | |
| 2.7% Xanthan | Thickener pregel | | 2.6% | 2.6 |
| gum + 1.35% | with biocide | | | |
| Proxel GXL in | | | | |
| water | | | | |

### Example 3—Biological Experiment, Efficacy of the Tau-Fluvalinate-CD Composition

Objective: Comparison of two compositions comprising tau-fluvalinate-CD complex to commercial insecticide product Mavrik® (tau-fluvalinate) in ingestion assay with Spodoptera Littorals 2nd instar larvae (L2).
Assay type: Ingestion of leaf disk at 60 mm Petri dishes. Assay duration was 96 hours.
16 petri dishes for each treatment with 2 L2 larva in each petri dish.
Total of 32 insects per treatment.
Treatments: The standard composition, i.e. Mavrik® 240EW, and two compositions comprising tau-fluvalinate-CD composition were each tested in 2 rates: 200 ppm and 400 ppm active ingredient.
Control: Tap water
Standard: Mavrik® 240EW
Compositions Comprising Tau-Fluvalinate-CD Complex: Tau-CD 200EG of the present invention (Example 1) Comparative Tau-CD 132EW (Example 3) (stored at ambient conditions for approx. 1 month before the application)

Procedure:

The tau-fluvalinate compositions were diluted in tap water at 200 ppm and 400 ppm, corresponding to EC50 and EC75.

Sunflower leaf discs were dipped in the tau-fluvalinate solutions and left to dry for 1.5 hours in fume hood.

The treated leaves were transferred to 60 mm plates and exposed to S. Littoralis larvae (L2). Evaluation of larvae mortality was performed 96 hours after exposure.

Commercial standard Mavrik® 240 EW was used as the reference. Tap water was used as the control.

Results:

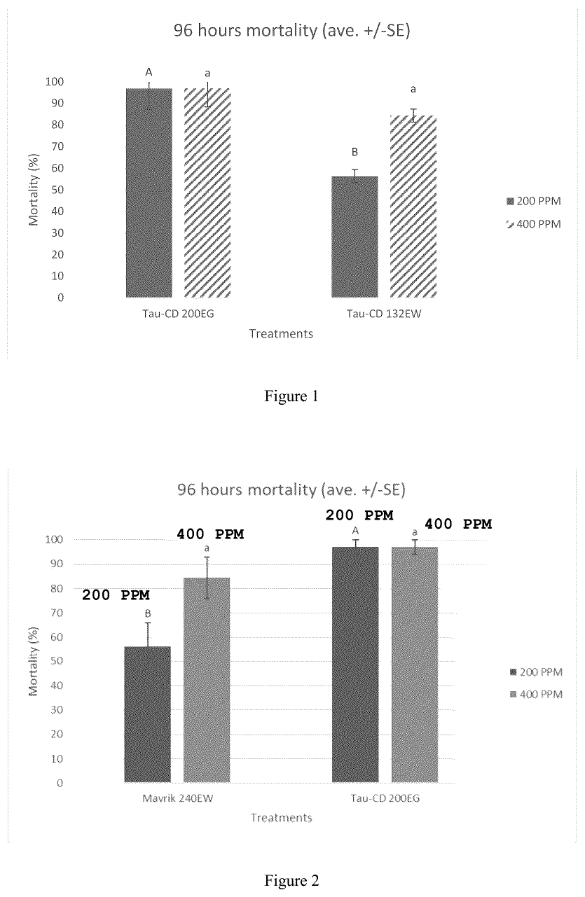

The results are shown in FIGS. 1 and 2. Levels not connected by same letter are significantly different according to Tukey-Kramer HSD test. Control mortality rate was 3.12%±3.02.

FIG. 1 compares the efficacy of the Tau-CD 200EG composition and the Tau-CD 132EW composition towards Spodoptera Littorals 2nd instar larvae. FIG. 1 shows that the Tau-CD 200EG composition has a higher efficacy than the Tau-CD 132EW composition.

FIG. 2 compares the efficacy of the Tau-CD 200EG composition and Mavrik® 240 EW towards Spodoptera Littorals 2nd instar larvae. FIG. 2 shows that the Tau-CD 200EG composition has a higher efficacy than Mavrik® 240 EW.

### Example 4—Biological Experiment

Sunflower leaf discs were dipped in tau-fluvalinate solutions as indicated. Four rates were tested, i.e. 50 ppm, 100 ppm, 150 ppm, and 200 ppm. The treated leaves were dried and exposed to S. Littoralis larvae (L2). Evaluation of larvae mortality was performed 96 hours after exposure. Commercial standard Mavrik® was used as reference (n=30; tap water was used as control).

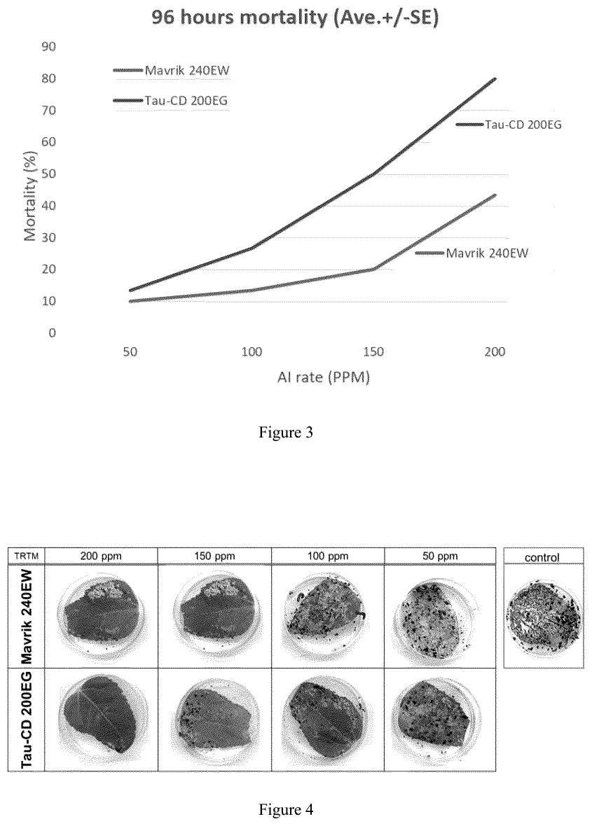

FIGS. 3 and 4 compare the efficacy of the Tau-CD 200EG composition and Mavrik® 240 EW towards Spodoptera Littorals 2nd instar larvae in Sunflower leaf discs lab trial.

FIGS. 3 and 4 show that the Tau-Fluvalinate-CD 200 EG demonstrates greater efficacy against Spodoptera littoralis compared to Mavrik® 240EW.

1. A solid composition comprising (1) a guest/host molecular structure comprising tau-fluvalinate and cyclodextrin, and (2) at least one agriculturally acceptable filler.

2. The solid composition of claim 1, wherein the solid composition is in the form of powder.

3. The solid composition of claim 2, wherein the powder is an emulsifiable powder.

4. The solid composition of claim 1, wherein the solid composition is in the form of granules.

5. The solid composition of claim 4, wherein the granule is an emulsifiable granule.

6. The solid composition of any one of claims 1-5, wherein the tau-fluvalinate molecules interact chemically with the cyclodextrin molecular matrix through intermolecular force(s).

7. The solid composition of any one of claims 1-6, wherein the tau-fluvalinate molecules are encapsulated within the cyclodextrin molecular matrix.

8. The solid composition of any one of claims 1-6, wherein the guest/host molecular structure is a complex of tau-fluvalinate and cyclodextrin.

9. The solid composition of claim 8, wherein the complex is in the form of a physical powder mixture blend.

10. The solid composition of any one of claims 1-9, wherein the cyclodextrin is α (alpha)-cyclodextrin: 6-membered sugar ring molecule. In some embodiments, the cyclodextrin is β (beta)-cyclodextrin: 7-membered sugar ring molecule. In some embodiments, the cyclodextrin is γ (gamma)-cyclodextrin: 8-membered sugar ring molecule.

11. The solid composition of any one of claims 1-10, wherein the cyclodextrin is alkylated.

12. The solid composition of any one of claims 1-11, wherein the cyclodextrin is a methyl-beta-cyclodextrin.

13. The solid composition of any one of claims 1-12, wherein the amount of cyclodextrin in the solid composition is between about 1% to about 90% by weight based on the total weight of the composition.

14. The solid composition of any one of claims 1-13, wherein the amount of cyclodextrin in the solid composition is between about 40% to about 50% by weight based on the total weight of the composition.

15. The solid composition of any one of claims 1-14, wherein the amount of cyclodextrin in the solid composition is about 46% by weight based on the total weight of the composition.

16. The solid composition of any one of claims 1-15, wherein the amount of tau-fluvalinate in the solid composition is between about 1% to about 45% by weight based on the total weight of the composition.

17. The solid composition of any one of claims 1-16, wherein the amount of tau-fluvalinate in the solid composition is about 20% by weight based on the total weight of the composition.

18. The solid composition of any one of claims 1-17, wherein the weight ratio of the tau-fluvalinate to the cyclodextrin in the solid composition is between 2:1 to 1:10.

19. The solid composition of any one of claims 1-18, wherein the weight ratio of the tau-fluvalinate to the cyclodextrin in the solid composition is between 1:1 to 1:4.

20. The solid composition of any one of claims 1-19, wherein the weight ratio of the tau-fluvalinate to the cyclodextrin in the solid composition is 1:1, 1:2, 1:3, or 1:4.

21. The solid composition of any one of claims 1-20, wherein the amount of the guest/host molecular structure comprising tau-fluvalinate and cyclodextrin in the solid composition is between about 20% to about 95% by weight based on the total weight of the composition.

22. The solid composition of any one of claims 1-21, wherein the amount of the guest/host molecular structure comprising tau-fluvalinate and cyclodextrin in the solid composition is between about 50% to about 70% by weight based on the total weight of the composition.

23. The solid composition of any one of claims 1-22, wherein the amount of the guest/host molecular structure comprising tau-fluvalinate and cyclodextrin in the solid composition is about 68% by weight based on the total weight of the composition.

24. The solid composition of any one of claims 1-23, wherein the agriculturally acceptable filler is water dispersible and/or water soluble.

25. The solid composition of any one of claims 1-24, wherein the agriculturally acceptable filler is a solid filler.

26. The solid composition of claim 25, wherein the solid filler is selected from the group consisting of lactose monohydrate, ammonium sulfate, sucrose, magnesium stearate, glucose, cellulose, calcium carbonate and any combination thereof.

27. The solid composition of any one of claims 1-26, wherein the amount of the agriculturally acceptable filler in the solid composition is between about 1% to about 30% by weight based on the total weight of the composition.

28. The solid composition of any one of claims 1-27, wherein the amount of the agriculturally acceptable filler in the solid composition is about 11.32% by weight based on the total weight of the composition.

29. The solid composition of any one of claims 1-28, wherein the solid composition comprises a water immiscible liquid.

30. The solid composition of claim 29, wherein the water immiscible liquid is an oil.

31. The solid composition of claim 30, wherein the oil is selected from the group consisting of vegetable or plant oils and esters thereof, mineral oils, paraffinic oils and any combination thereof.

32. The solid composition of claim 31, wherein the vegetable or plant oil is selected from the group consisting of safflower oil, sunflower oil, pine oil, linseed oil, castor oil, rapeseed oil, soybean oil, and esters thereof.

33. The solid composition of any one of claims 30-32, wherein the oil is methylated soybean oil.

34. The solid composition of claim 29, wherein the water immiscible liquid is a water immiscible organic solvent.

35. The solid composition of claim 34, wherein the water immiscible organic solvent is selected from the group consisting of aromatic hydrocarbons, ketones, amides, pyrrolidones and any combination thereof.

36. The solid composition of claim 35, wherein:
a. the aromatic hydrocarbon is a naphtha solvent,
b. the ketone is cyclohexanone, 2-heptanone or a combination thereof,
c. the amide is N,N dimethyl decanamide, and/or
d. the pyrrolidone is N-octyl pyrrolidone (NOP).

37. The solid composition of any one of claims 29-36, wherein the amount of the water immiscible liquid in the solid composition is from about 0.1% to about 10% by weight based on the total weight of the composition.

38. The solid composition of any one of claims 1-37, wherein the amount of the water immiscible liquid in the solid composition is about 3.4% by weight based on the total weight of the composition.

39. The solid composition of any one of claims 1-38, wherein the solid composition comprises at least one disintegration agent.

40. The solid composition of claim 39, wherein the disintegration agent is a blooming agent, an effervescence system or a combination thereof.

41. The solid composition of claim 39 or 40, wherein the solid composition comprises an effervescent system.

42. The solid composition of claim 41, wherein the effervescent system comprises a mixture of an acid and a base.

43. The solid composition of claim 41 or 42, wherein the effervescent system comprises a mixture of sodium bicarbonate and citric acid.

44. The solid composition of any one of claims 39-43, wherein the amount of the disintegration agent in the solid composition is about 0.1% to about 30% by weight based on the total weight of the composition.

45. The solid composition of any one of claims 39-44, wherein the amount of the disintegration agent in the solid composition is about 11.32% by weight based on the total weight of the composition.

46. The solid composition of any one of claims 1-45, wherein the solid composition comprises at least one additive.

47. The solid composition of claim 46, wherein the additive is selected from the group consisting of dispersing agents, wetting agents, emulsifying agents, anti-foaming agent, biocides, water absorbents, water scavengers, adjuvants and any combination thereof.

48. The solid composition of claim 46 or 47, wherein the composition comprises at least one wetting agent.

49. The solid composition of claim 48, wherein the wetting agent is selected from the group consisting of sodium alkylnaphthalenesulfonate, sodium phenolsulfonic acid, polycondensed formaldehyde, alcohol ethoxylate, sodium lauryl sulfate, polyalkoxylated butyl ether, polyarylphenyl phosphate ether, sodium ducosate, and any combination thereof.

50. The solid composition of claim 49, wherein the amount of the wetting agent in the composition is between about 0.10% to about 10% by weight based on the total weight of the composition.

51. The solid composition of any one of claims 46-50, wherein the composition comprises at least one emulsifying agent.

52. The solid composition of claim 51, wherein the emulsifying agent is selected from the group consisting of alkyl sulfonates, alkyl benzene sulfonates, alkylaryl sulfonates, alkyl phenol alkoxylates, tristyryl phenol ethoxylates, synthetic or natural fatty ethoxylates alcohols synthetic or natural fatty, block copolymers, synthetic or natural fatty alcohol alkoxylates, alkoxylated alcohols, polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or poly-oxyalkylene, quaternary ammonium compounds and fatty amine salts, salts of alkylaryl sulfonic acids, salts or sulfated polyglycol ethers, salts of phosphated polyglycol ether and any combination thereof.

53. The solid composition of claim 51 or 52, wherein the emulsifying agent is a linear dodecyl benzene sulfonate in 2-ethylhexanol.

54. The solid composition of any one of claims 51-53, wherein the amount of the emulsifying agent in the solid composition is between about 0.01% to about 10% by weight based on the total weight of the composition.

55. The solid composition of any one of claims 46-54, wherein the solid composition comprises at least one dispersing agent.

56. The solid composition of claim 55, wherein the dispersing agent is selected from the group consisting of condensate of alkyl naphthalene sulfonate formaldehyde, alkoxylated alcohol, silicone surfactant, methyl naphthalene sulfonate condensate, sodium salt, ethoxylated fatty alcohol, hydrophobically modified polyacrylate, lignosulfonates, polyelectrolyte block copolymer and any combination thereof.

57. The solid composition of claim 55 or 56, wherein the dispersing agent comprises a block polymer comprises 77% of sodium 2-acryloylamino-2-methylpropane-1-sulfonate (AMPS) monomers and 23% of the ethyl acrylate (EA) monomers.

58. The solid composition of any one of claims 55-57, wherein the dispersing agent is a vinyl pyrrolidone/vinyl acetate copolymer.

59. The solid composition of claim 55, wherein the composition comprises two dispersing agents.

60. The solid composition of claim 59, wherein the two dispersing agents are vinyl pyrrolidone/vinyl acetate copolymer and PVP-vinyl acetate copolymer.

61. The solid composition of any one of claims 55-60, wherein the amount of the dispersing agent(s) in the solid composition is between about 1% to about 10% by weight based on the total weight of the composition.

62. The solid composition of any one of claims 1-61, wherein the solid composition comprises at least one additional active ingredient.

63. The solid composition of any one of claims 1-62, wherein the solid composition comprises a secondary alcohol ethoxylate and/or linear dodecyl benzene sulfonate in 2-ethylhexanol.

64. A solid composition comprising (1) tau-fluvalinate, (2) cyclodextrin, and (3) at least one agriculturally acceptable filler.

65. A package comprising the solid compositions of any one of claims 1-64.

66. A package comprising a solid composition comprising a guest/host molecular structure comprising tau-fluvalinate and cyclodextrin

67. An oil-in-water emulsion comprising the solid composition of any one of claims 1-64 and water.

68. An oil-in-water emulsion comprising (1) a guest/host molecular structure comprising tau-fluvalinate and cyclodextrin, and (2) at least one dispersing agent.

69. The oil-in-water emulsion of claim 68, wherein the dispersing agent is selected from the group consisting of condensate of alkyl naphthalene sulfonate formaldehyde, alkoxylated alcohol, silicone surfactant, methyl naphthalene sulfonate condensate, sodium salt, ethoxylated fatty alcohol, hydrophobically modified polyacrylate, lignosulfonates, polyelectrolyte block copolymer and any combination thereof.

70. The oil-in-water emulsion of claim 68 or 69, wherein the dispersing agent comprises a block polymer comprises 77% of sodium 2-acryloylamino-2-methylpropane-1-sulfonate (AMPS) monomers and 23% of the ethyl acrylate (EA) monomers.

71. The oil-in-water emulsion of any one of claims 68-70, wherein the dispersing agent is a vinyl pyrrolidone/vinyl acetate copolymer.

72. The oil-in-water emulsion of claim 68 or 69, wherein the composition comprises two dispersing agents.

73. The oil-in-water emulsion of claim 72, wherein the two dispersing agents are vinyl pyrrolidone/vinyl acetate copolymer and PVP-vinyl acetate copolymer.

74. The oil-in-water emulsion of any one of claims 68-73, wherein the oil-in-water emulsion comprises a water immiscible liquid.

75. The oil-in-water emulsion of claim 74, wherein the water immiscible liquid is an oil.

76. The oil-in-water emulsion of claim 75, wherein the oil is selected from the group consisting of vegetable and plant oils and esters thereof, mineral oils, paraffinic oils and any combination thereof.

77. The oil-in-water emulsion of claim 75 or 76, wherein the oil is methylated soybean oil.

78. The oil-in-water emulsion of claim 74, wherein the water immiscible liquid is a water immiscible organic solvent.

79. The oil-in-water emulsion of claim 78, wherein the water immiscible organic solvent is selected from the group consisting of aromatic hydrocarbons, ketones, amides, pyrrolidones and any combination thereof.

80. The oil-in-water emulsion of claim 79, wherein:
a. the aromatic hydrocarbon is a naphtha solvent,
b. the ketone is cyclohexanone, 2-heptanone or a combination thereof,
c. the amide is N,N dimethyl decanamide, and/or
d. the pyrrolidone is N-octyl pyrrolidone (NOP).

81. A method for controlling plant disease caused by insect, comprising contacting a plant, a locus thereof or propagation material thereof with an effective amount of the oil-in-water emulsion of any one of claims 67-80 so as to thereby control the plant disease.

82. A method for controlling plant disease caused by insect, comprising (1) obtaining the oil-in-water emulsion of any one of claims 67-80, and (2) contacting a plant, a locus thereof or propagation material thereof with an effective amount of the oil-in-water emulsion so as to thereby control the plant disease.

83. A method for controlling plant disease caused by insect, comprising (1) obtaining the solid composition of any one of claims 1-64, (2) mixing the solid composition with water to obtain an oil-in-water emulsion, and (3) contacting a plant, a locus thereof or propagation material thereof with an effective amount of the oil-in-water emulsion so as to thereby control the plant disease.

84. The method of any one of claims 81-83, wherein the method is effective for preventing the plant disease caused by insects and/or curing the plant disease caused by insects.

85. A method for controlling unwanted insects comprising applying an effective amount of the oil-in-water emulsion of any one of claims 67-80 to an area infested with the unwanted insects so as to thereby control the unwanted insects.

86. A method for controlling unwanted insects comprising (1) obtaining the oil-in-water emulsion of any one of claims 67-80, and (2) applying an effective amount of the oil-in-water emulsion to an area infested with the unwanted insects so as to thereby control the unwanted insects.

87. A method for controlling unwanted insects comprising (1) obtaining a solid composition described herein, (2) mixing the solid composition of any one of claims 1-64 with water to obtain an oil-in-water emulsion, and (3) applying an effective amount of the oil-in-water emulsion to an area infested with the unwanted insects so as to thereby control the unwanted insects.

88. The method of any one of claims 85-87, wherein the area infested with unwanted insects is a plant or soil.

89. The method of any one of claims 85-88, wherein the method is effective for preventing infestation by unwanted insects and/or reducing the number of unwanted insects in the area.

90. The method of any one of claims 81-89, wherein the oil-in-water emulsion is applied as a persistence treatment or a knockdown treatment.

91. The method of any one of claims 81-90, wherein the oil-in-water emulsion is applied at a rate from about 100 ppm to about 1000 ppm of tau-fluvalinate.

92. The method of any one of claims 81-91, wherein the oil-in-water emulsion is applied at a rate from about 200 ppm to about 400 ppm of tau-fluvalinate.

93. The method of any one of claims 81-92, wherein the oil-in-water emulsion is applied to soil and/or foliage.

94. Use of cyclodextrin for (i) solidifying tau-fluvalinate, (ii) preparing a solid composition comprising tau-fluvalinate, or (iii) preparing a guest/host molecular structure comprising tau-fluvalinate.

95. A process for preparing a solid composition comprising tau-fluvalinate, comprising (1) solidifying an amount of tau-fluvalinate using cyclodextrin, and (2) formulating the solidified tau-fluvalinate into a solid composition.

96. A process for preparing the solid composition of any one of claims 1-64 comprising (1) obtaining a guest/host molecular complex comprising tau-fluvalinate and cyclodextrin, and (2) mixing at least one additional agriculturally acceptable filler with the guest/host molecular complex.

97. The process of claim 96, comprising (1) obtaining a guest/host molecular structure comprising tau-fluvalinate and cyclodextrin, (2) mixing the guest/host molecular structure with at least one agriculturally acceptable filler, (3) wet granulation of the mixture of step (2) using a wetting liquid to obtain granules, and (4) drying the obtained granules.

98. The process of claim 96, comprising (1) obtaining a guest/host molecular structure comprising tau-fluvalinate and cyclodextrin, (2) mixing the guest/host molecular structure with at least one agriculturally acceptable filler, (3) wetting the mixture of step (2) in a mixer using a wetting liquid to obtain a non-compacted powder, (4) drying the non-compacted powder so-obtained.

99. The process of claim 97, wherein the wetting liquid is sprayed onto the mixture of step (2) to obtain granules.

100. The process of any one of claims 96-99, wherein the guest/host molecular structure comprising tau-fluvalinate and cyclodextrin is prepared using a melting-in process, kneading process, or a co-precipitation process.

101. The process of any one of claims 96-100, wherein step (2) further comprises mixing the guest/host molecular structure with at least one additive.

102. The process of any one of claims 96-101, wherein a water immiscible liquid is mixed with the guest/host molecular structure during wetting.

103. The process of any one of claims 96-102, wherein:
a. the wetting liquid used in step (3) is an aqueous liquid,
b. the wetting liquid used in step (3) is an emulsion of at least one water immiscible liquid in water, or
c. the wetting liquid used in step (3) is an emulsion of an oil-comprising component in water.

104. The process of any one of claims 96-103, wherein the weight ratio of the wetting liquid to the guest/host molecular structure is from about 1:1 to about 1:10.

105. The process of any one of claims 96-103, wherein the weight ratio of the wetting liquid to the guest/host molecular structure is 1:5.5.

106. The process of any one of claims 96-105, wherein a disintegration agent is mixed with the guest/host molecular structure prior to performing the wet granulation of step (3).

107. The process of any one of claims 96-106, wherein the wet granulation is pan granulation.

108. The process of any one of claims 96-107, wherein:
a. the obtained granules are dried using a fluidized bed,
b. the obtained granules are dried by lyophilization of the remaining solution,
c. the obtained granules are dried by spray-drying,
d. the obtained granules are dried freeze-drying,
e. the obtained granules are dried by diafiltration,
f. the obtained granules are dried by dialysis,
g. the obtained granules are dried by vacuum drying, and/or
h. the obtained granules are dried by heat drying.

109. A process for preparing the solid composition described herein comprising (1) obtaining a guest/host molecular complex comprising tau-fluvalinate and cyclodextrin, and (2) wet-granulation of the guest/host molecular complex with at least one water immiscible liquid and water.

110. A solid composition prepared using the process of any one of claims 95-109.

111. A process for preparing the oil-in-water emulsion of any one of claims 67-80 comprising mixing the solid composition of any one of claims 1-64 with water.

112. A process for preparing the oil-in-water emulsion of any one of claims 67-80 comprising (1) obtaining a guest/host molecular complex comprising tau-fluvalinate and cyclodextrin, and (2) mixing the guest/host molecular complex with at least one water immiscible liquid and water.

113. The process of claim 112, wherein the guest/host molecular structure comprising tau-fluvalinate and cyclodextrin is prepared using a melting-in process, kneading process, or a co-precipitation process.

114. The process of claim 112 or 113, wherein step (2) of the process comprises (i) mixing the guest/host molecular complex and at least one emulsifier in a water immiscible liquid to prepare an oil phase, (ii) dissolving at least one wetting agent and/or dispersing agent in water to prepare a water phase, and (iii) mixing the oil phase with the water phase to prepare the oil-in-water emulsion.

115. The process of any one of claims 112-114, wherein the water immiscible liquid is an oil.

116. The process of claim 115, wherein the oil is methylated soybean oil.

117. The process of any one of claims 112-116, wherein the process further comprises mixing the guest/host molecular structure with at least one agriculturally acceptable filler, additive, and/or disintegration agent.

118. An oil-in-water emulsion prepared using the process of any one of claims 111-117.
